(19) United States
(12) Patent Application Publication
(10) Pub. No.: US 2005/0052983 A1
(43) Pub. Date: Mar. 10, 2005

(54) Method and apparatus for electro-optical disk memory

(76) Inventors: Kent D. Vincent, Cupertino, CA (US); Sean Xiao-An Zhang, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/658,217

(22) Filed: Sep. 9, 2003

(51) Int. Cl. G11B 9/00; G11B 7/24

(52) U.S. Cl. 369/126; 369/275.2; 369/108

(57) ABSTRACT

Methods and apparatus are described for a rewritable disk memory using an electro-optical molecular recording layer. In the manner of nanotechnology, each molecule is an individual multi-position switch having at least two distinct optical characteristic states. Localized electrical field injection is used to switch each molecule to one of at least two bistable position states such that each is representative of a storable data bit.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO AN APPENDIX

Not applicable.

### BACKGROUND

1. Technical Field

This disclosure relates generally to disk memories.

2. Description of Related Art

In U.S. Pat. No. 6,556,470, issued on Apr. 29, 2003, and assigned to the common assignee herein, Kent Vincent, Xiao-an Zhang, and R. Stanley Williams, describe FIELD ADDRESSABLE REWRITABLE MEDIA, incorporated herein by reference in its entirety, including the Appendix thereof (which is selected text of allowed U.S. patent application Ser. No. 09/844,862, filed Apr. 27, 2001 by Zhang et al.), hereinafter referred to simply as the “Vincent '470 patent.” In summary, an electrochromic molecular colorant and a plurality of uses as an erasably writeable medium are described. Substrates are adapted for receiving a coating of the colorant. Electrical fringe fields or through-fields are used to transform targeted pixel molecules between a first optical state and second optical state, providing information content having resolution and viewability at least equal to hard copy document print.

One problem associated with known manner magnetic, magneto-optic, and compact disk/digital video disk (CD/DVD) rewritable optical memories is the relatively slow speed associated with writing data. For example, with magnetic storage, writing speed is limited by the inductive impedance of the magnetic write head. As another example of a cause of relatively slow write times, optical storage media use phase-change recording layers where write time is related to thermally crystallizing the media for each bit. Such prior art systems typically achieve only a microsecond-per-bit write time at best. Data density is similarly limited, including limitations inherent in miniaturization of the magnetic particles used for data bit storage. Moreover, magnetic field spread requires accommodative track spacing which lowers total storage capacity.

CD and DVD memories are generally limited in storage capacity and performance by the achievable field of view of the read-write laser head.

There is a need for improvements to electro-optical disk memories.

### BRIEF SUMMARY

The basic aspects of the invention generally provide for an electro-optical disk memory having a rewritable layer employing molecular-level read-write storage mechanisms.

The foregoing summary is not intended to be inclusive of all aspects, objects, advantages and features of the present invention nor should any limitation on the scope of the invention be implied therefrom. This Brief Summary is provided in accordance with the mandate of 37 C.F.R. 1.73 and M.P.E.P. 608.01 (d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 is a schematic, perspective view in accordance with a first exemplary embodiment of the present invention, including enlarged detail sections in partially exploded views.

FIG. 2 is a schematic elevation view demonstrating a read-write process in accordance with the exemplary embodiment as shown in FIG. 1.

FIG. 3 is a block diagram of an exemplary system for employing the exemplary embodiments of the present invention as shown in FIGS. 1 and 2.

Like reference designations represent like features throughout the drawings. The drawings in this specification should be understood as not being drawn to scale unless specifically annotated as such.

### DETAILED DESCRIPTION

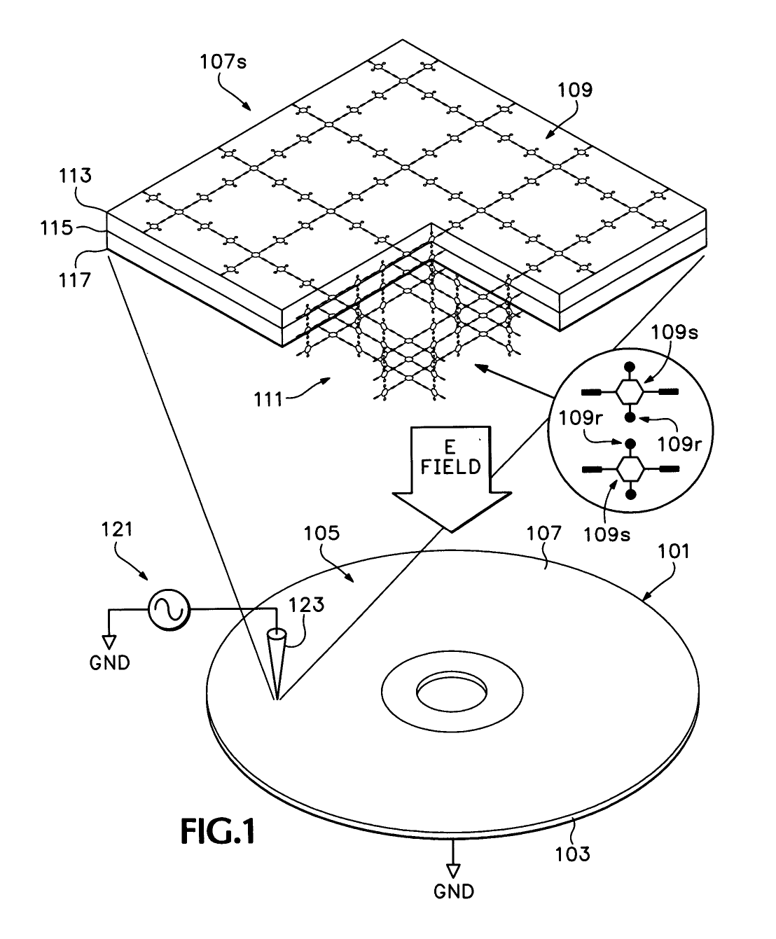

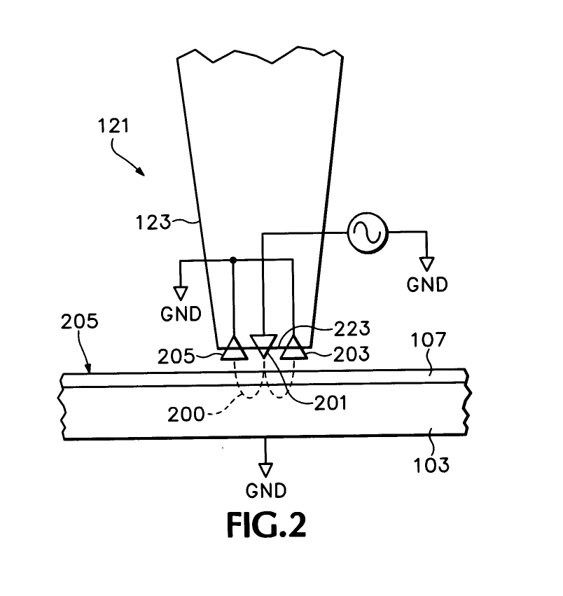

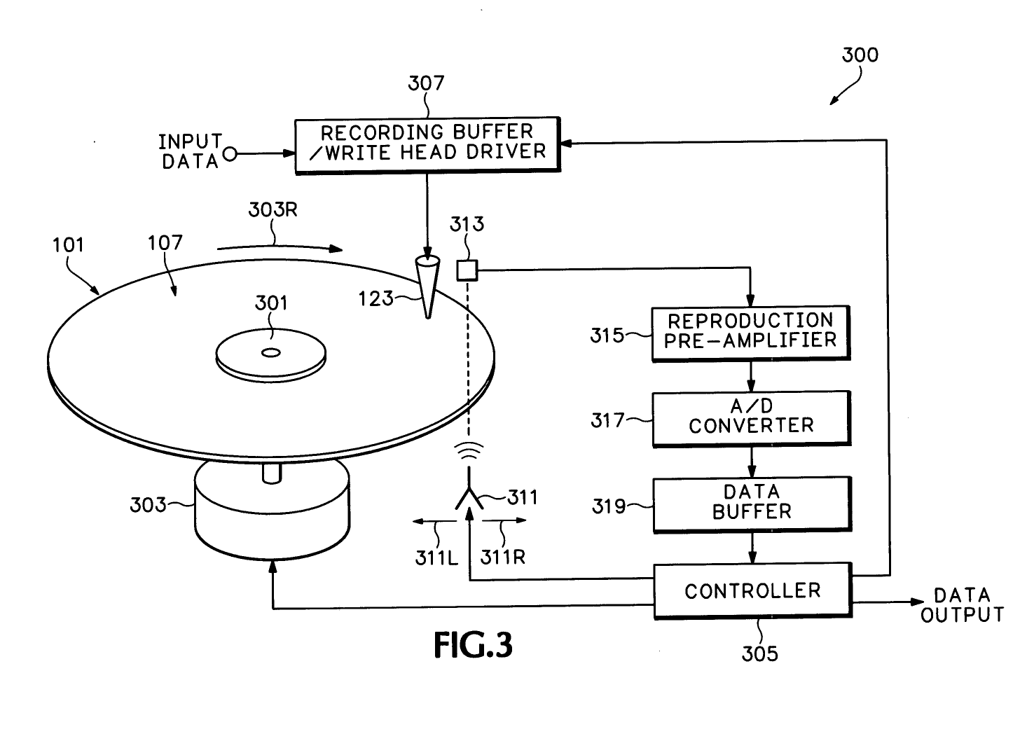

FIG. 1 is a schematic, perspective view of a data storage memory 101 in accordance with a first exemplary embodiment of the present invention, including enlarged detail sections in partial exploded views. The storage memory 101 is a rotating disk 103 type rewritable memory device. The disk 103 itself also acts as a recording medium substrate, wherein the recording medium thereon is a molecular colorant; for example, see the Vincent '470 patent. The disk 103 may be fabricated in a known manner using metals, glass, ceramic, plastic, or other materials as common to the state of the art. As described in detail hereinafter, the storage memory 101 has digital data erasably written on the recording medium by using localized electrical fields. The disk 103 substrate may be electrically grounded; illustrated by the arrow labeled “GND.” If a non-conductive material is used to fabricated the disk, a grounded, metalized bottom surface may be employed. The grounded disk 103 provides a grounded backplane electrode of the storage memory 101. Alternatively, given an appropriate fringe field write head as described in the Vincent '470 patent with respect to FIG. 3AA and as shown in FIG. 2 described hereinafter, grounding of the disk 103 may become unnecessary.

On a recording, or “read-write,” surface 105 of the disk 103 is a data storage recording medium 107. The recording medium 107 is an electrical-field controlled, switchable, molecular colorant, coated or otherwise affixed in a known manner onto the read-write surface 105. The Vincent '470 patent incorporated herein by reference, and particularly the Appendix thereto, describes the details of the types of molecules 109 used in forming the recording medium 107. For the main part, the colorant forms a recording medium as a layer on a surface of the disk which is a molecular-level operating system including electrochromic, switchable molecules, each of said molecules being selectively switchable between at least two optically distinguishable states. A small segment 107s of the recording medium 107 is shown exploded in view, in a partially transparent illustrative representation of a molecular structure 111 employed in accordance with the present invention. As illustrated, the recording medium 107 is preferably a construction that comprises substantially uniform, planar strata, illustrated herein as three stratum 113, 115, 117. In practice, the number of strata will be dependent upon the specific molecules 109 employed and the thickness of the recording medium 107. The recording layer is preferably a molecularly self-assembling, interconnected stratum creating a uniform, precisely spaced, conjugated, molecular lattice structure 111. Recognizing that each molecule 109 is effectively an individual molecular switch, it can be recognized that even a known manner thin film deposition onto the recording surface of the disk 103 will form a lattice of the molecular colorant recording medium 107 that includes several hundreds or thousands of stratum, depending on the thickness.

Each molecule 109 is capable of a band gap transforming conformation change under the influence of an electric field. The band gap transformation occurs via molecular level mechanisms such as (1) molecular conformation change or an isomerization, (2) a change of extended conjugation via chemical bonding change, or (3) molecular folding or stretching; see Vincent '470, particularly the Appendix. In the preferred embodiments of the present invention, each molecule 109 has a one or more aromatic rings having electrical dipoles and can rotate out of the plane of the molecule with an appropriately applied electric field wherein electron conjugation along the molecule is altered, also sometimes referred in the art to as broken, interrupted or destroyed. In this manner each molecule effectively has a construction that can be considered in electromechanical terms as having a construction in the nature of:
rotor 109r--connector--stator 109s, wherein “--connector--” represents an atomic level interconnect. Thus, the lattice structure 111 in effect forms a recording layer 111 which is a matrix of individual molecular-level switches.

In general, each switch has at least two stable optical states—that is, each molecule 109 is at least bistable and at least bichromal. In one exemplary embodiment, the molecule is absorptive of light when fully planar and transparent to light when conjugation is broken. Thus, provided with a suitably adapted write-erase head of a data recording device 121 and a light emitter-detector device, and using these molecules 109 to form an electro-optical switchable colorant layer as a recording medium 107 on a rotatable disk 103, a system is created for forming a data storage medium, or “disk memory device,” 101.

A variety of write-erase heads can be implemented for use in the system. The Vincent '470 patent and Vincent et al. in U.S. patent application Ser. No. 10/981,131 (assigned to the common assignee herein and incorporated herein by reference), describe a variety of such writing instruments.

FIG. 2 is a schematic elevation view demonstrating one exemplary write-erase head, or a “recording device,” 121 and an exemplary write process in accordance with the exemplary embodiment as shown in FIG. 1. Optical states of individual molecules, or supersets of many latticed molecules forming a predetermined volume of the recording medium 107—which may be considered by some practiced in the art as a single molecule when self-assembling mechanisms are employed for fabricating the molecular matrix—can be used to define one data bit. Data bits, are reversibly recorded, or “written,” by a localized electric fringe field, selectively generated by the recording device 121, that passes through the recording medium 107. The data recording device 121 includes an electrical stylus 123. In writing data, the stylus 123 is brought into contact or near-contact relationship with the recording medium 107. An implementation-optimized, small aperture electric field—represented by the phantom lines 200 emitted by the center electrode 201 of the stylus 123 tip 223 and returning along the two side electrodes 203, 205—is applied selectively to the recording medium 107 to write data bits. In other words, the bit density of the recording medium 107 is determined by the line width of the electric field 200. Therefore, the main limitation on bit density will be with the scalable dimension of the electrodes 201, 203, 205 of the stylus 123 and the read head resolution as described in more detail hereinafter. Note that the resolution will be a function of the available state-of-the-art technology for miniaturizing the extent of the field 200; therefore, given such read-write head advancements to the state-of-the-art, it is contemplated that even a single molecule electro-optical memory cell can be implemented. Spacing between the stylus tip 223 and the recording layer surface 205—sometimes referred to in the art as the “flying height” when the stylus tip 223 is not in contact with the surface to prevent wear, crash damage, and the like—will also be a factor affecting bit density. Thus, it can be seen that with advances to the state of the art of stylus 123, or to a combined read-write head, miniaturization, the accessible bit density of the recording layer is molecular in scale. That is, each molecule 109, FIG. 1, having a
rotor 109r--molecular connector--stator 109s
   construction, is an individual bistable switch capable of representing a digital “1” or digital “0” data bit depending on its currently set, bistable, state. In other words, for the current state of the art for read-write heads, the rotational state of the rotors of a superset of molecules 109 at each data bit position along the recording medium 107 determines the data bit state at that position of the disk 103 surface 105. As an analogy, one can think of a superpixel in a visual color image where each visible superpixel may actually comprise an array of smaller pixels. Thus, a data bit is reversibly written electrically, by using a stylus 123 generated local electrical field 200 passing through the recording medium 107 between the stylus tip 223 and the disk 103 substrate ground potential. In one exemplary embodiment, the recording medium 107 has data bits represented by regions absorptive of incident light by a molecule or predetermined superset of molecules is in one of the bistable modes, representing a first data bit molecular configuration, and data bits represented by regions transmissive of incident light in the other of the bistable modes, representing a second data bit molecular configuration; e.g., absorptive molecule(s) can be a digital one or digital zero with the transmissive molecule(s) being complementary thereto.

With appropriately adapted read heads, other configurations for at least two-bit determinative data modes may be implemented. For a two optical state molecule, the alternative bit regions may be (1) reflective and transmissive, or (2) differential reflective or differential absorptive, or (3) differential refractive indexed. Note that in addition to the visible light spectrum, implementations can be tailored for infrared and ultraviolet spectral radiation as well.

It is to be specifically recognized that using combinations for data modes is a recognized implementation; e.g., reflective/white=1, absorptive/black=0, and transmitted and separately received=a third datum state. Moreover, recognizing different reflected colors—e.g., where the molecules switch between red and yellow may also be indicative of different data bit states. Also note that optical recording and recognition of a variety of colors may be used for multi-statible data.

FIG. 3 is a simplified block diagram of an exemplary system for employing the exemplary embodiments of the present invention. The system 300 schematically depicts read-write components of what is generally referred to commercially as a “disk drive.”

The memory disk 101 having the recording medium 107 is mounted on a spindle 301 connected to a motor 303. Rotational motion, represented by arrow 303R, is selectively imparted to the disk 101 by the motor 303 under control a controller unit 305. The controller unit 305, such as a microprocessor or application specific integrated circuit (ASIC) based printed circuit board, provides known manner firmware or software based instructions for both data handling and disk read-write-erase operations. “INPUT DATA”—e.g., from a host computer, not shown—is received by recording buffer/write head driver circuitry 307 which is used by the controller unit 305 to write erasably onto the memory disk 101.

Note that it is recognized that translating media over read-write heads is an alternative to relative rotational and radial juxtapositioning. This is also described in co-pending U.S. patent application Ser. No. 10/264,811 by Vincent et al., assigned to the common assignee herein, for FIELD ADDRESSABLE REWRITABLE MEDIA.

Once a disk 101 recording medium 107 is written on as described hereinbefore, it has a recording layer with discrete regions representative of digital data bits in that data bit regions in this particular exemplary embodiment of the layer are either absorptive of incident light and either reflective of incident light—where for example the disk substrate is metal, metal oxide, metal halide, metal sulfide, silicon nitride, or inorganic materials—or transmissive of incident light, where for example the disk substrate is a transparent plastic. The exemplary embodiment shown in FIG. 3 illustrates the latter.

A read head 311 is a light source directed at the disk 101 and movable along a radius of the disk, illustrated by horizontal arrows 311L, 311R. The transmitted light for transmissive bit regions is captured by a photodetector 313. That is, in this exemplary embodiment in general, at a given spectral band used to read the data bits, data bit states are differentiated as photon absorbent where the colorant molecules are in an opaque state, and either photon transparent down to the reflective substrate 103 or photon transmissive where the colorant molecules are in a transparent state. The photodetector 313 signals are processed in a known manner by means of circuitry for reproduction amplification 315, analog-to-digital conversion 317, and buffering 319 back to the controller 305 for “DATA OUTPUT.” It will be recognized by those skilled in the art that a combined read-write head can be implemented as a single unit subsystem.

In the aforesaid manner, the colorant is a plurality of stratum of a matrix structure forming a regular lattice of said molecules such that predetermined volumes of said colorant form predetermined targetable positions of said memory means wherein each of said positions is a memory location of the disk for writing and erasing using the localized electrical field and reading using a known manner optical emitter-detector.

While FIG. 3 represents data bits using a mechanism for a two optical state molecule where the alternative bit regions are reflective and transmissive, it can now be recognized that simple modifications can be implemented for bit regions that are differentially reflective such as by having a detector for recognizing gray scale differences. Similarly a detector may be employed which is sensitive to bit regions that are differentially absorptive. Additionally, by employing molecules where the states are differentially refractive indexed, and employing a detector that senses the specific light path changes of a read head incident beam, the same results can be achieved. It is specifically recognized that combinations of these three modes of recording data may also be employed.

The media surface recording medium 107 may be constructed to meet data bit standards currently in use for current and future CD and DVD data storage apparatus. In the current state of the art, for a low cost implementation, the recording medium 107 may be on a reflective, e.g., polished aluminum, disk substrate 103. Incident light passes through each transmissive data bit area and reflects back. This allows the use of low cost, commercially laser emitter-detector components common to CD and DVD formats.

It can now be recognized that given the adapted read-write head technology, in accordance with the present invention it is possible to increase data memory such that each data bit is stored in a single molecule. Such technology is sometimes referred to in the art as “nanotechnology” in that one or a few molecules form a machine. In the present invention, that machine is a bichromal, bistable, electrically controlled switch. That is, with the present invention the data domain of each data bit can be on the order of merely several Angstroms or nanometers, which is orders of magnitude greater compared to state of the art CD and DVD technology where state-of-the-art bit size is limited to about 400 nanometers. Even using current state of the art write heads produced with known manner semiconductor fabrication techniques and read heads where minimum field of view is much greater than the molecular level, in computer modeling, simulations or experiments conducted by the inventors, switching time—that is, data recording—can be reduced to 10⁻⁹ seconds.

As described hereinabove, the present invention thus provides a method and apparatus for a rotating disk rewritable memory using an electro-optical molecular recording layer. In the manner of nanotechnology, each molecule is an individual switch having two distinct optical characteristic states. Localized electrical field injection is used to switch each molecule to one of two bistable states such that each is representative of a digital data bit.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements during the term of the patent, and that adaptations in the future may take into consideration those advancements, in other word adaptations in accordance with the then current state of the art. It is intended that the scope of the invention be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase
“comprising the step(s) of . . . ”

1. A data storage disk device comprising:
a substrate; and
on a surface of the substrate, a data recording medium, wherein said medium is a molecular colorant in which each molecule is reversibly switchable via a localized electrical field for selecting one of at least two optically differentiated states and wherein predetermined regions of said layer are used for erasably writable data bit storage.

2. The device as set forth in claim 1 comprising:
said at least two optically differentiated states are defined by molecular-level spectral absorptive characteristics, molecular-level reflective characteristics, molecular-level refractive characteristics, molecular-level transmissive characteristics, or combinations thereof.

3. The device as set forth in claim 1 comprising:
said at least two optically differentiated states are defined by molecular-level differential spectral reflective characteristics.

4. The device as set forth in claim 1 comprising:
said at least two optically differentiated states are defined by molecular-level spectral absorptive characteristics.

5. The device as set forth in claim 1 comprising:
said at least two optically differentiated states are defined by molecular-level differential spectral refractive index characteristics.

6. The device as set forth in claim 1 comprising:
said at least two optically differentiated states are defined by molecular-level differential spectral transmissive characteristics.

7. The device as set forth in claim 1 comprising:
each said molecule is bichromal and bistable or multichromal and multistable.

8. The device as set forth in claim 1 comprising:
each said molecule exhibits a bistable or multistable electric field induced band gap change.

9. The device as set forth in claim 8 comprising:
said band gap change occurs via a molecular conformation change or an isomerization.

10. The device as set forth in claim 9 comprising:
each said molecule has at least one stator portion and at least one rotor portion, wherein said rotor portion rotates from a first state to a second state selectively via said localized electrical field, wherein in the first state there is extended conjugation resulting in a relatively small band gap, and in said second state said extended conjugation is altered resulting in a relatively larger band gap.

11. The device as set forth in claim 9 comprising:
dependent upon direction of the localized electrical field applied, in the first state the molecule is in a more conjugated state having a relatively smaller band gap and in the second state the molecule are in a less conjugated state having a relatively larger band gap.

12. The device as set forth in claim 8 comprising:
said electric field induced band gap change occurs via a change of extended conjugation via chemical bonding change to change the band gap.

13. The device as set forth in claim 12 comprising:
said electric field induced band gap change occurs via a change of extended conjugation via charge separation or recombination accompanied by increasing or decreasing band localization.

14. The device as set forth in claim 12 comprising:
a change from a first state to a second state occurs with an applied electric field, said change involving charge separation in changing from said first state to said second state, resulting in a relatively larger band gap state, with less n-delocalization, and recombination of charge in changing from said second state to said first state, resulting in a relatively smaller band gap state, with greater π-delocalization.

15. The device as set forth in claim 8 comprising:
said electric field induced band gap change occurs via a change of extended conjugation via charge separation or recombination and π-bond breaking or formation.

16. The device as set forth in claim 15 comprising:
a change from a first state to a second state occurs with an applied electric field, said change involving charge separation in changing from said first state to said second state, wherein in said first state there is extended conjugation throughout with a separation of positive and negative charge, resulting in a relatively smaller band gap state, and wherein in said second state said extended conjugation is destroyed or partially interrupted and separated positive and negative charges are recombined, resulting in a relatively larger band gap state.

17. The device as set forth in claim 8 comprising:
said electric field induced band gap change occurs via a molecular folding or stretching.

18. The device as set forth in claim 17 comprising:
said molecule has three portions, a first portion and a third portion, each bonded to a second, central portion, wherein a change from a first state to a second state occurs with an applied electric field, said change involving a folding or stretching about of said second portion, wherein in said first state there is extended conjugation, resulting in a relatively smaller band gap state, and wherein in said second state, said extended conjugation is altered or destroyed, resulting in a relatively larger band gap.

19. A disk drive apparatus comprising:
a disk, having a recording medium formed of at least one stratum forming a lattice of molecules wherein each molecule is at least bichromal and switchable between at least two bistable optical characteristic differentiated molecular states such that each of said states represents a predetermined data bit;
a motor coupled to said disk for providing rotational motion thereto;
proximate said recording layer, a writing stylus for selectively imparting electrical fields to said molecules for writing and erasing a data bit;
proximate said recording layer, a photo-optical device for transmitting to said layer and receiving from said layer spectral radiation wherein said each data bit is read from said disk; and
a controller, connected to said motor, said writing stylus, and said photo-optical device and providing electrical controls therefor.

20. The apparatus as set forth in claim 19 comprising;
each data bit is one of said states, differentiated at a given spectral band used to read the data bits as a first state wherein a molecule is photon absorbent and a second state wherein a molecule is photon transparent.

21. The apparatus as set forth in claim 19 comprising:
each data bit is one of said states, differentiated at a given spectral band used to read the data bits as a first state defined by a molecular-level differential first spectral reflective characteristic and a molecular-level differential second spectral reflective characteristic.

22. The apparatus as set forth in claim 19 comprising:
each data bit is one of said states, differentiated at a given spectral band used to read the data bits as first state defined by a molecular-level first spectral absorptive characteristic and a molecular-level second spectral absorptive characteristic.

23. The apparatus as set forth in claim 19 comprising:
said states are defined by molecular-level differential spectral refractive index characteristics.

24. The apparatus as set forth in claim 19 comprising:
each said molecule exhibits a bistable or multistable electric field induced band gap change.

25. The apparatus as set forth in claim 19 wherein said photo-optical device includes means for differentiating reflective and transmissive characteristics of regions of said lattice, or differential reflective or differential absorptive characteristics of regions of said lattice, or differential refractive indexed characteristics of regions of said lattice, or combinations thereof as representative of specific data states.

26. A disk memory comprising:
substrate means for forming a disk shaped substrate; and
memory means for forming a recording layer on said substrate such that said layer is an electro-optical colorant having electrically switchable, at least bistable and at least bichromal molecules in a matrix structure wherein each of said molecules may be erasably set to a memory state representative of a data bit.

27. The disk memory as set forth in claim 26 wherein said molecules are each selectively switchable between at least two optically distinguishable states.

28. The disk memory as set forth in claim 26 wherein said molecules exhibits a bistable electric field induced band gap change.

29. The disk memory as set forth in claim 26 wherein said colorant is a plurality of stratum of said matrix structure forming a regular lattice of said molecules such that predetermined volumes of said colorant form predetermined targetable positions of said memory means wherein each of said positions is an addressable memory location.

30. A method for storing data on a disk, the method comprising:
affixing a colorant onto a recording surface of said disk wherein said colorant is a substantially uniform layer of molecules wherein each molecule thereof is at least bichromal and at least bistable and selectively switchable between at least two optically distinct states by localized electrical fields; and
storing data on said disk by selectively manipulating said localized electrical fields for forming digital data bits via setting said distinct state in predetermined regions of said colorant.

31. The method as set forth in claim 30 wherein a storage data density characteristic of said disk is defined by approximating an area of said colorant substantially equal to size of a single molecule.

32. The method as set forth in claim 30 wherein a storage data density characteristic of said disk is defined by a predetermined area approximately equal to a predetermined optically targetable region of said colorant.

33. The method as set forth in claim 30 wherein said data is rewritable via selectively manipulating said localized electrical fields.

34. The method as set forth in claim 30 wherein said two optically distinct states are predetermined for reading said data bits via a given spectral band used related to said states.

35. A method for erasably writing on an electrical field addressable rewritable disk medium, the method comprising:
providing a disk-shaped substrate having at least one layer of a molecular colorant coating wherein molecules of the coating are at least bichromal and subjectable to switching between stable states under influence of a localized electric field and wherein said layer is distributed across said substrate forming targetable individual data bit locations on said medium; and
electrically addressing said locations by selectively controlling each said localized electric field to form erasably memorized data content on said medium such that each of said locations is optically readable as a data bit.

36. A digital data memory system comprising:
a rotatable disk having a surface; and
means for storing optically discernable digital data bits on said surface, said means for storing further comprising a molecular colorant further comprising a matrix of molecules wherein each molecule is a bistable, bichromal, electro-optical switch.

37. The system as set forth in claim 36 comprising:
said means for storing is a molecularly self-assembling, interconnected stratum forming a uniform, spaced, conjugated, molecular lattice structure.

38. The system as set forth in claim 36 comprising:
each said switch has two optically differentiated states defined by molecular-level spectral absorptive characteristics, molecular-level reflective characteristics, molecular-level refractive characteristics, molecular-level transmissive characteristics, or combinations thereof.

39. The system as set forth in claim 36 comprising:
each said molecule exhibits a bistable band gap change under influence of a localized electrical field.

40. The system as set forth in claim 36 further comprising:
means for writing and erasing digital data on said means for storing; and
means for reading digital data from said means for storing.
